(19) United States
(12) Patent Application Publication
(10) Pub. No.: US 2026/0077563 A1
(43) Pub. Date: Mar. 19, 2026

(54) VERTICAL SCREEN FRAME LAMINATOR

(71) Applicant: Erdman Automation Corporation, Princeton, MN (US)

(72) Inventors: Morgan W. Donohue, North Oaks, MN (US); Peter J. Kroll, Saint Stephen, MN (US); Andrew D. Peterson, Zimmerman, MN (US)

(21) Appl. No.: 18/889,180

(22) Filed: Sep. 18, 2024

(51) Int. Cl. B29C 65/00; B29C 65/02

(52) U.S. Cl. CPC B29C 66/45; B29C 65/02

(57) ABSTRACT

A vertical mesh to flexible screen frame laminator, including a vertically oriented supporting frame and a back frame having a structure presenting multiple elongate horizontal openings therethrough. Movable, retractable and advanceable pins are supported and configured to extend and retract through the horizontal openings and to be movable parallel to a long axis of the horizontal openings A heater roller assembly is movable in a plane parallel to the back frame. A mesh material support interfaces with, suspends and supports mesh material between the back frame and the heater roller assembly. The mesh material support may optionally include carding cloth.

### TECHNICAL FIELD

Embodiments of the invention relate generally to removable window and door screens. In particular, example embodiments of the invention relate to the manufacturing of removable window screens that include a flexible frame that is resilient and a flexible mesh material that is bonded to the flexible frame.

### BACKGROUND

Fenestrations exist in buildings to permit ingress and egress, entry of fresh air and light. Screens have been used in these openings for many years to permit the entry and exit of air while excluding insects, debris, leaves and other undesired materials. Currently screens generally include a mesh material supported by a frame that holds the mesh material taut and facilitates insertion of the screen into the frame of a fenestration. For the purposes of this application, the term fenestration refers to any opening in the outside envelope of a building structure including but not limited windows and doors.

In many modern window screens, a fiberglass mesh is supported in a frame. Other mesh materials commonly include nylon, polyester, bronze, stainless steel, aluminum, copper, brass and galvanized steel. Meshes made of fiberglass, nylon and polyester are generally quite flexible, while meshes that are made of stainless steel, aluminum, copper, brass and galvanized steel are relatively less flexible.

Screen frames are commonly made of rigid materials such as extruded aluminum, wood, steel or polymers. Occasionally, screens are made without a perimeter frame. In this case the screens are stretched taut over an opening often by a roller under spring tension.

More recently, other screen frames are made of flexible materials with resilient qualities. For example, some flexible screen frames are made from resilient steel that is coated with a polymer material. In many cases, the screen mesh is fused to the flexible screen frame by the application of heat which renders the polymer material of the screen frame, the screen mesh or both at least partially molten during the manufacturing of the screen. When the polymer material returns to its non-molten state the screen mesh is fused and strongly bound to the screen frame.

Such flexible screens are typically inserted into rigid fenestration frames by distorting the flexible window screen, generally by pushing inwardly on parallel rectilinear sides of the flexible window screen and then inserting the flexible window screen into grooves that surround the rigid fenestration frame on an inside of the fenestration frame. Similarly, flexible screens are generally removed by distorting the screen frame which then permits taking the screen frame out of the grooves. To facilitate this, the flexible screen frame is generally resiliently biased outwardly toward an approximately rectangular shape.

Currently, manufacturing of flexible window screen frames and flexible window screens is largely done by manual processes that are labor-intensive. These processes tend to be inefficient and time-consuming. Thus, rapid production of flexible screen frames and screens is not available.

Flexible screen frames are formed from spring metal such as spring steel that is bent to the shape of the screen and so that terminal ends of the metal material abut one another. Generally, the abutting ends of the flexible screen frame are located away from corners of the frame but not at a center of a straight side of the screen frame. The spring material is coated with a polymer material such as polyvinylchloride (PVC) also referred to as vinyl. Other polymer material coatings are, of course, possible.

Flexible screen frames are formed of spring material so that they can be deformed inwardly, inserted into a window frame and then be held in place by the resilience of the flexible screen frame material springing outwardly. Deformation of the flexible screen frame is generally accomplished by pressing inwardly on two opposing straight sides of the screen frame.

The abutting terminal ends of the shaped frame are welded to each other to form a closed geometric shape, most commonly a rectangle or a square. Resistance welding is commonly used.

To facilitate the welding of the abutting ends of the frame, the polymer coating material must first be removed from the metal core material. Failure to remove the polymer material interferes with establishing electrical contact with the metal core of the frame material necessary for electrical welding and may result in contamination of any weld that is performed with the coating material present. Contaminated welds are often of inferior quality and may not hold up to the flexing encountered during insertion and removal of the flexible screen frame from a window or door structure.

Following welding of the abutted metal core ends it is good practice to clean the area of the weld to remove weld flash or spatter and possibly to mitigate any mushrooming of the abutted ends that may occur during the welding process.

It is also desirable to apply a new polymer coating over the stripped and welded area of the frame to mitigate corrosion and to facilitate adhesion of screen mesh in the area surrounding the weld. This is commonly accomplished by slipping a portion of heat shrink tube over the frame material prior to welding to join the abutting ends and moving the heat shrink material away from the portion to be welded until it is welded, cleaned and cooled. After the welding is performed, post weld cleaned and cooled the heat shrink tube is located to cover the previously stripped and welded portion and heat is applied to shrink it. The level of heat required to shrink the heat shrink tube is considerably less than that related to welding.

Fusing of screen mesh material to flexible screen frame material requires the application of heat and pressure to the materials to create a plastic welded permanent fusion between the screen mesh material and the flexible screen frame material. This creates a durable and self-securing flexible framed window screen which is less prone to damage and easier to handle than more conventional screen frames.

These processes are typically manually performed.

Accordingly, there is still room for improvement in the manufacturing of flexible window screens.

### SUMMARY

A vertical mesh laminator according to example embodiments of the invention addresses many of the above discussed concerns.

According to an example embodiment, the vertical mesh laminator includes a generally vertical supporting frame on which flexible screen frame structures may be placed and supported to facilitate lamination of screen mesh to the flexible screen frame. For the purposes of this disclosure vertical is considered to be within fifteen degrees of absolute vertical. This orientation is considered to be substantially vertical for the purposes of this application.

According to an example embodiment, the vertical screen mesh laminator generally includes a supporting frame having a back frame with multiple horizontal openings or slots therethrough which are sized and structured to allow retractable pins of the gantry sweep to pass through the horizontal openings. Retractable pins at a first side of the vertical screen mesh laminator for example the right side secure one side of the flexible screen frame and keep the right side of the frame straight and rectilinear while pins at the left side are adjustable in location to accommodate different sized screen frames. The retractable pins support the flexible screen frame material and align the frame sides to a square and rectilinear orientation prior to lamination of the screen mesh to the frame. This facilitates keeping the finished flex screen straight and square.

In an example embodiment, the vertical screen frame laminator utilizes carding cloth to support the screen mesh material prior to and during fusing and laminating the screen mesh material to the screen frame. Carding cloth includes many fine pins that according to an example embodiment of the invention are spaced to pass through openings in the mesh and to facilitate quickly hanging and supporting the mesh which is then largely tensioned by gravity in at least one direction.

In another example embodiment, screen mesh material is prebonded to an upper portionof the screen frame prior to and during fusing and laminating the screen mesh material to the screen frame.

A movable heater roller structure of the vertical screen mesh laminator is movable in x-y axes on a gantry support in front of the screen frame and mesh. The heater roller structure includes a heater and a roller. Each of heater rollers is further structured to be shiftable between a noncontact position and a contact position. In the contact position, the heater rollers are arranged to pinch flexible screen frame material between the roller and the back frame so that the flexible screen frame material can be fused to the mesh. The heater roller or the mesh and frame material may be heated by for example hot air or by electrical resistance. According to another example embodiment, heated air is applied directly to the mesh and the frame to fuse the mesh material to the polymer coating of the screen frame material.

A roller of the heater roller structure is rotatable about a z-axis at least 90° and according to a further example embodiment by at least 270°. This facilitates applying heat and pressure to all four sides of a typical flexible screen frame and mesh to fuse the screen mesh to the flexible screen frame.

The XY gantry accommodates any pattern needed or desired to secure the screen mesh material to the frame by heating and rolling. According to one example embodiment the heater roller structure is rotatable by at least 90°. According to another example embodiment rotation is at least 270°. Patterns utilized to heat and roll the mesh to fuse it to the screen frame include for example starting at the upper left-hand corner of the screen frame and securing the top mesh to the upper side of the screen frame and then the left side of the mesh material followed by securing the right side and then the bottom of the mesh material to the flexible screen frame material. This example pattern should not be considered limiting. Any pattern can be used.

According to another example embodiment, the invention includes a method of laminating screen mesh to flexible screen frame material including: placing a flexible screen frame on a substantially vertical supporting frame; placing screen mesh overlying and proximate to the flexible screen frame supported by carding cloth in a substantially vertical orientation;

Alternately, screen mesh can be supported by fusing it in advance to at least a portion of the upper edge of the flexible screen frame fusing the screen mesh to the substantially vertical flexible screen frame by application of heat and pressure.

The method further includes applying the heat and the pressure to the screen mesh and flexible screen frame by application of a heater roller assembly.

The method further includes moving the heater roller assembly proximate the flexible screen frame and screen mesh material by operation of a substantially vertically oriented X-Y movable gantry.

The method further includes supporting the flexible screen frame on optionally retractable pins.

The method further includes selectively advancing and retracting the pins through horizontally oriented slots in a back frame.

The method further includes straightening sides of the flexible screen frame by application and movement of the optionally retractable pins.

The method further includes tensioning the screen mesh in at least one axis by the operation of gravity.

The method further includes moving the heater roller assembly around a perimeter of the flexible screen frame while rotating the roller about a z-axis at corners of the flexible screen frame.

The method further includes rotating the roller about a z-axis by a rotation selected from the group consisting of at least 90° and at least 270°.

The method further includes removing a laminated window screen from the vertical screen frame laminator to a remote location for trimming of excess mesh material.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of a Vertical Screen Laminator according to an example embodiment of the invention;

FIG. 2 is a front elevational view of the Vertical Screen Laminator as depicted in FIG. 1;

FIG. 3 is a side elevational view of the Vertical Screen Laminator as depicted in FIG. 1;

FIG. 4 is a perspective view of a laminator head according to an example embodiment of the invention;

FIG. 5 is a perspective view of a gantry sweep according to an example embodiment of the invention;

FIG. 6 is a top plan view of the vertical screen laminator;

FIG. 7 is an elevational view of the laminator head with parts in a first orientation; and

FIG. 8 is an elevational view of the laminator head with parts in a second orientation.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

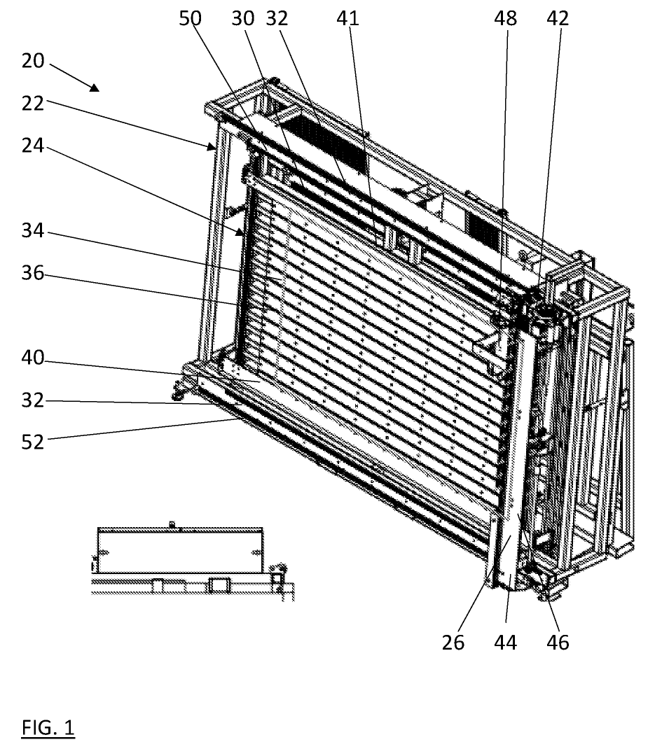

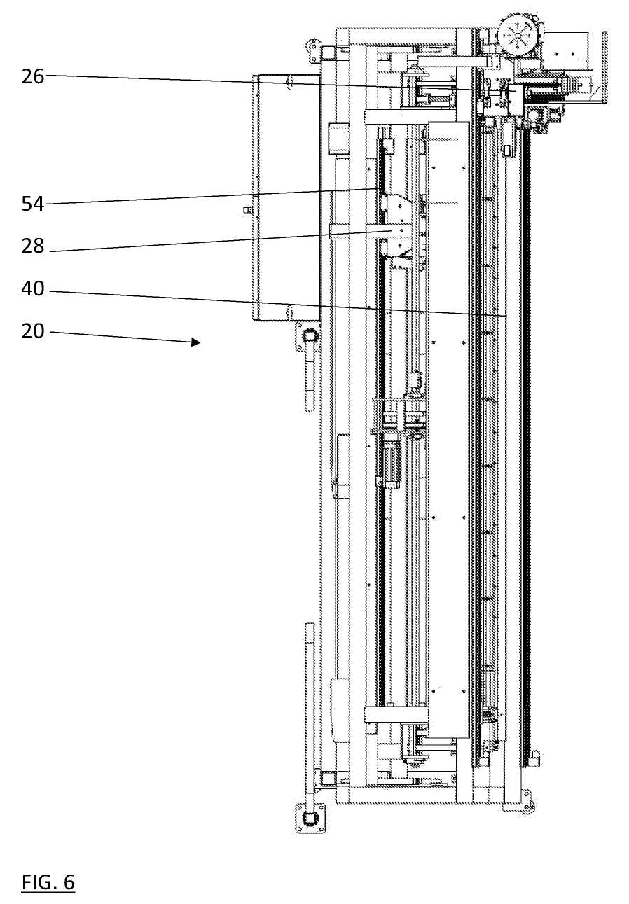

Referring to FIGS. 1-6, vertical screen laminator 20 generally includes supporting frame 22, back frame 24, laminator head gantry 26, gantry sweep 28 and mesh materials support 30.

Supporting frame 22 supports back frame 24 in a substantially vertical orientation. A substantially vertical orientation for the purposes of this application is within 15° of true vertical. Supporting frame 22 further supports laminator head gantry 26 on laminator gantry tracks 32. Supporting frame 22 also supports gantry sweep 28 behind back frame 24. Gantry sweep 28 is movably supported so that it can travel horizontally.

Back frame 24 generally includes horizontal slats 34 defining slots 36 therebetween. Back frame 24 further includes fixed pin assembly 38, frame support rail 40 and upper frame support rail 41. Horizontal slats 34 are oriented horizontally and parallel to one another and are evenly spaced apart to define slots 36. Horizontal slats 34 are consistent in width and spacing. In the depicted embodiment, fixed pin assembly 38 is located to the right of back frame 24 when viewed from the front of the vertical screen laminator 20.

Fixed pin assembly 38 presents a plurality of fixed pins 42 that are aligned vertically and fixed in location horizontally relative to back frame 24. According to an example embodiment fixed pins 42 may be extendable and retractable so as to extend outwardly from back frame 24 and to be retractable behind back frame 24.

Frame support rail 40 is located proximate a lower edge of back frame 24 in the depiction and extends horizontally. Frame support rail 40 extends outwardly in front of back frame 24 at least a distance sufficient to support screen frames to be laminated. Frame support rail 40 and upper frame support rail 41 are each movable in a vertical direction while remining parallel so that a distance between them is adjustable to accommodate different sized flexible screen frames to be laminated. This adjustability further facilitates operator ergonomics as frame support rail 40 and upper frame support rail 41 can be positioned to receive screen frames to be laminated at a height comfortable for the operator. Vertical movement of frame support rail 40 and upper frame support rail 41 can be accomplished by coupling each of frame support rail 40 and upper frame support rail 41 to a toothed belt (not shown) that is translated by toothed pulleys (not shown) that are under computer control.

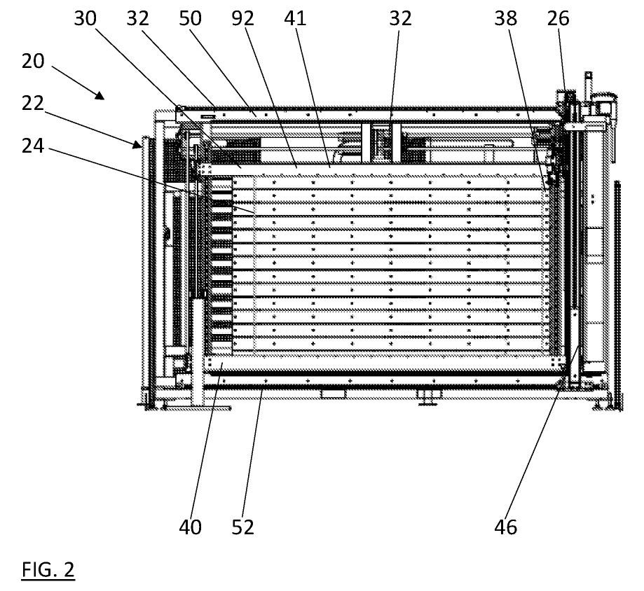

Referring particularly to FIGS. 1 and 2 laminator head gantry 26 generally includes upper traveling portion 42, lower traveling portion 44, vertical girder 46 and laminator head 48. Upper traveling portion 42 movably engages with and travels on upper gantry track 50. Lower traveling portion 44 movably engages with and travels on lower gantry track 52. Vertical girder 46 is maintained in a substantially parallel relationship with back frame 24. Vertical frame girder 46 is oriented relative to vertical at a similar angle to back frame 24. Laminator head 48 is movably engaged with vertical girder 46 and travels relative to vertical girder 46 while maintaining a substantially consistent distance from back frame 24.

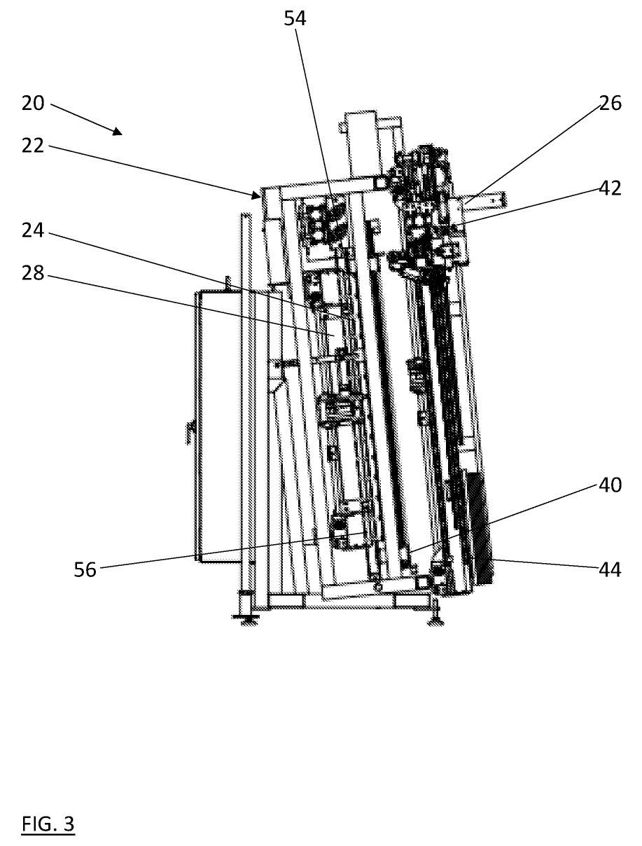

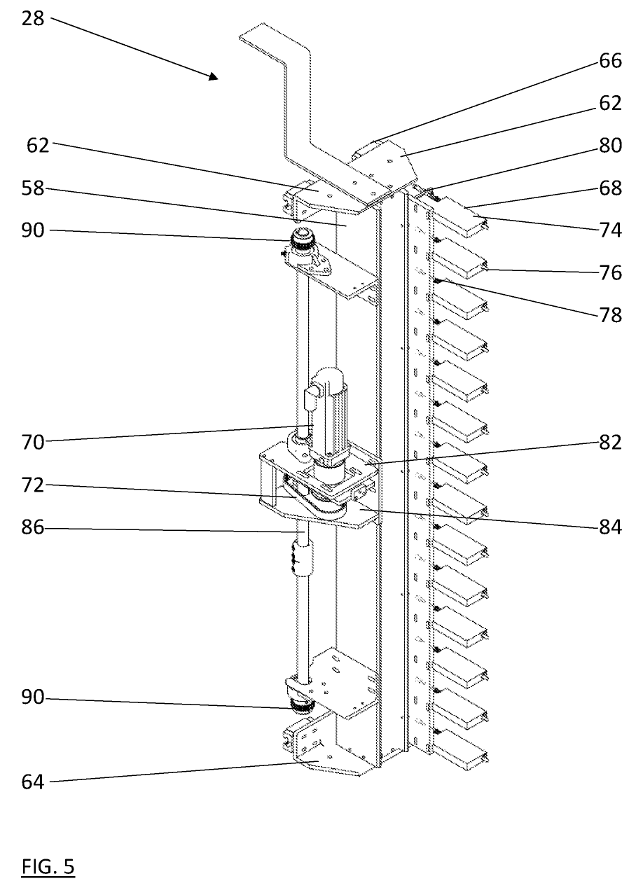

Referring particularly to FIGS. 3 and 5, gantry sweep 28 is positioned behind back frame 24. Gantry sweep 28 movably engages with upper sweep track 54 and lower sweep track 56. As is visible in FIG. 5, gantry sweep 28 generally includes vertical beam 58, pin support rail 60, upper flange plate 62, lower flange plate 64, track sliders 66, pin fixtures 68, sweep motor 70 and sweep transmission 72. Vertical beam 58 extends substantially vertically and substantially parallel to back frame 24. Vertical beam 58 is coupled to upper flange plate 62 and lower flange plate 64. Each of upper flange plate 62 and lower flange plate 64 support track sliders 66. Track sliders 66 are adapted to engage upper sweep track 54 and lower sweep track 56 in a slidable fashion. Pin support rail 60 extends outwardly from vertical beam 58 and toward back frame 24. Pin support rail 60 supports a plurality of pin fixtures 68. Sweep motor 70 and sweep transmission 72 are coupled to vertical beam 58.

Each of a plurality of pin fixtures 68 includes pin block 74, retractable pin 76, spring 78 and spring support 80. Pin block 74 supports retractable pin 76 in a passage therethrough. Retractable pin 76 is biased toward an extended orientation by spring 78 which is in turn supported by spring support 80. In the depicted embodiment, fourteen pin fixtures 68 are shown, each being secured to pin support rail 60. Typically, the number of pin fixtures is equal to the number of horizontal slots in back frame 24 but this should not be considered limiting. Pin blocks 74 are sized, positioned and shaped to slidably engage within horizontal slots 36 of back frame 24.

In the depicted embodiment, sweep motor 70 is mounted on motor plate 82. Sweep transmission 72 is mounted on transmission plate 84. In the depicted embodiment sweep transmission 72 includes belt drive 86, drive shaft 88 and friction wheels 90. Sweep motor 70 is operably coupled to sweep transmission 72 which in turn transmits power to driveshaft 88. Friction wheels 90 transfer power to move gantry sweep 28 as required or instructed under computer control.

Mesh material support 30, according to an example embodiment, generally includes carding cloth 92 to support screen mesh material prior to and during fusing and laminating the screen mesh material to the screen frame. Carding cloth includes many fine pins that according to an example embodiment of the invention are spaced to pass through openings in the mesh and to facilitate quickly hanging and supporting the mesh which is then largely tensioned by gravity in at least one direction. Mesh material support 30 can also support mesh material by other approaches. For example, vacuum or clamping.

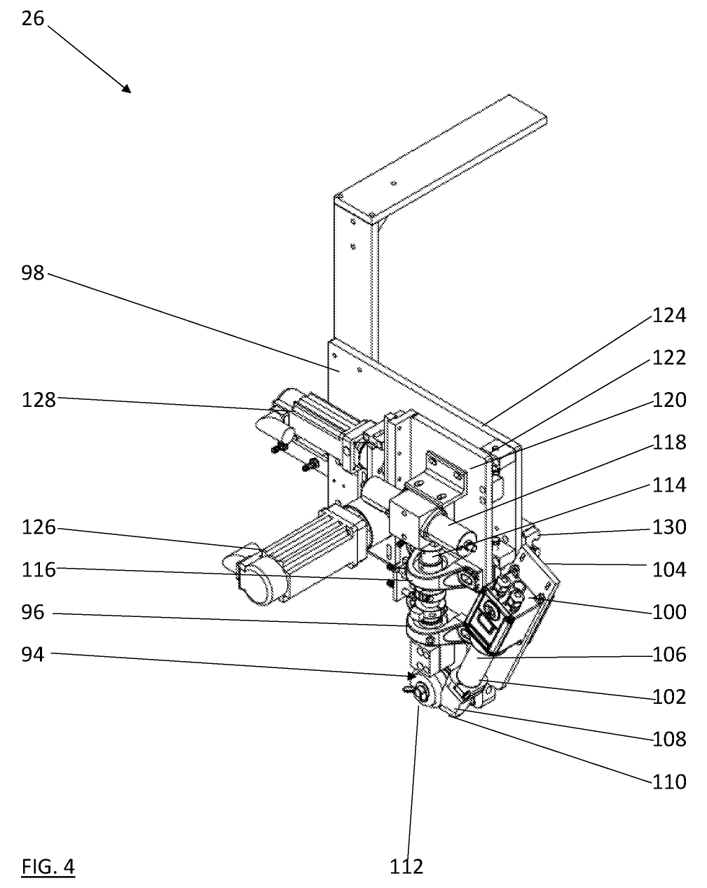

Referring particularly to FIG. 4, laminator head 48 generally includes heater roller assembly 94, rotation assembly 96 and gantry slide 98.

Heater roller assembly 94 generally includes upper portion 100, lower portion 102, support plate 104, heater 106, heater manifold 108, heater nozzle 110 and roller wheel 112. Upper portion 100 is fixedly coupled to support plate 104. Lower portion 102 extends outwardly away from upper portion 100. Heater 106 is coupled to heater manifold 108 and structured to direct heated air through heater manifold 108 to heater nozzle 110. Heater nozzle 110 is located adjacent to roller wheel 112 and directs heated air proximate roller wheel 112.

Still referring to FIG. 4, rotation assembly 96 generally includes rotation shaft 114, pillow blocks 116, rotation actuators 118, translation plate 120 and translation slide 122. Rotation shaft 114 is operably coupled to heater roller assembly 94 and is rotationally supported by pillow blocks 116. Pillow blocks 116 are secured to translation plate 120. Rotation actuators 118 are also secured to translation plate 120 and to rotation shaft 114 and control rotation of rotation shaft 114. Translation plate 120 is slidably secured to gantry slide 98 by translation slides 122.

Gantry slide 98 generally includes plates 124, first motor 126, second motor 128 and slide channel 130. First motor 126 and Second motor 128 are supported on plates 124. First motor 126 is operably coupled to translation plate 120 to move translation plate 120 relative to plates 124. Second motor 128 is operably coupled to laminator head gantry 26 to move plate 124 relative to gantry. Slide channel 130 is slidably coupleable to laminator head gantry 26.

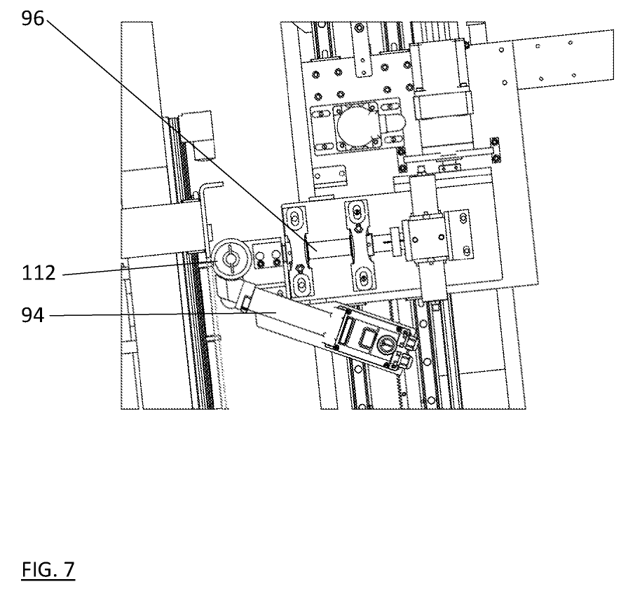

Referring to FIG. 7, laminator head 26 is depicted in a first orientation with roller wheel 112 positioned in contact with a vertically oriented portion of flexible window screen material. In this orientation heated air is applied via heater nozzle 110 to screen mesh and the vertical portion of flexible window frame material and then translated vertically downward to fuse the screen mesh and flexible window frame material.

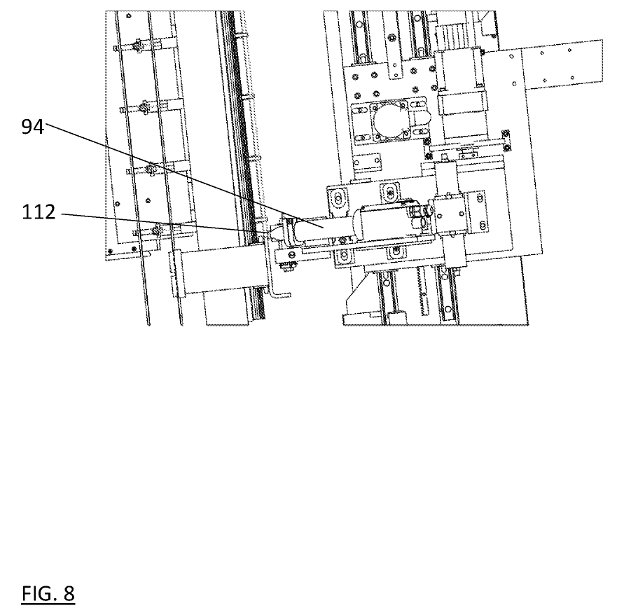

Referring to FIG. 8, laminator head 26 is depicted in a second orientation with roller wheel 112 positioned in contact with a horizontally oriented portion of flexible screen frame material along a horizontal portion lower portion of the flexible screen frame. In this orientation heated air is applied via heater nozzle 110 to screen mesh and the horizontal portion of flexible window frame material while roller wheel 112 is translated horizontally to fuse the screen mesh and flexible window frame material by application of heat and pressure.

In operation, an operator places a flexible screen frame to which mesh is to be fused proximate back frame 24. The operator then places a portion of mesh material to be fused to the screen frame supported by mesh material support 30. The flexible screen frame is abutted against fixed pin assembly 38 to the right side of back frame 24. Gantry sweep 28 is positioned so that pins 76 abut a left side of the flexible screen frame. The screen frame rests on top of frame support rail 40 and against upper supporting rail 41. Mesh material support 30 if present including carding cloth 92 supports screen mesh material along a top portion thereof allowing the screen mesh material to tension via gravity. Left and right here relate to the depicted embodiment of the invention. Those skilled in the art will recognize these directions can be reversed.

In an alternate embodiment, mesh material is pre-bonded to at least a portion of the flexible screen frame to be laminated. This portion may include an upper portion of the flexible screen frame.

As perhaps best seen in FIGS. 7 and 8, laminator head gantry 26 is then activated under computer control. Heater roller assembly 94 is shifted to bring roller wheel 112 into contact with mesh material and to press mesh material against the flexible screen frame. Heater roller assembly 94 is moved so that roller wheel 112 presses the mesh against the frame while heated air is directed through heater tube 106 to heater manifold 108 and directed from heater nozzle 110 to heat the polymer coating of the screen frame and of the mesh material. This causes fusion of the mesh material to the screen frame under pressure from roller wheel 112.

When roller wheel run 12 reaches a corner of the flexible screen frame, heater roller assembly 94 is rotated as can be seen by comparison of FIGS. 7 and 8. Roller wheel assembly 12 is for example rotated and then is moved along a side of the flexible screen frame adjacent to the first side. This process continues until all four sides of the flexible screen frame are fused to the screen mesh material applied. Computer control of the laminator had gantry 26 can control laminator head gantry 26 to fuse the sides of the flexible screen frame in any desired sequence. For example, the sequence might include fusing a top of the flexible screen frame first followed by the two vertical sides of the flexible screen frame followed by the bottom of the flexible screen frame.

Once fusion of the mesh material and the flexible screen frame is completed, the flexible screen frame with attached mesh material can be removed for trimming of excess mesh and further processing.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to producenumerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A vertical mesh to flexible screen frame laminator, comprising:
a substantially vertically oriented supporting frame;
a substantially vertically oriented back frame having a structure presenting multiple elongate horizontal openings therethrough;
fixed pins extending outwardly forwardly from the back frame and oriented in a first rectilinear line;
movable, retractable and advanceable pins supported and configured to extend and retract through the horizontal openings and to be movable parallel to a long axis of the horizontal openings oriented in a second rectilinear line;
a frame support rail and an upper frame support rail oriented parallel to the frame support rail; and
a heater roller assembly movable in a plane parallel to the back frame.

2. The vertical mesh to flexible screen frame laminator as claimed in claim 1, further comprising a movable gantry upon which the heater roller assembly is movable on X and Y axes.

3. The vertical mesh to flexible screen frame laminator as claimed in claim 1, wherein the heater roller structure further comprises a roller that is rotatable about a Z axis by at least ninety degrees.

4. The vertical mesh to flexible screen frame laminator as claimed in claim 1, wherein the heater roller assembly further comprises a source of heated air that can be directed at a flexible screen frame and screen mesh and which is rotatable about a Z axis by at least ninety degrees.

5. The vertical mesh to flexible screen frame laminator as claimed in claim 1, further comprising a mesh material support that interfaces with and suspends and supports mesh material between the back frame and the heater roller assembly.

6. The vertical mesh to flexible screen frame laminator as claimed in claim 5, wherein the mesh material support further comprises carding cloth including a large number of fine pins or wires spaced so as to be easily passable through openings in screen mesh material.

7. The vertical mesh to flexible screen frame laminator as claimed in claim 6, wherein the carding cloth is located at an upper portion of the vertically oriented supporting structure.

8. A method of laminating screen mesh to a flexible screen frame material, comprising:
placing a flexible screen frame on a substantially vertical supporting frame between and in close proximity to each of a frame support rail and an upper frame support rail;
placing a portion of screen mesh overlying and proximate to the flexible screen frame wherein the screen mesh is in a substantially vertical orientation; and
fusing the screen mesh to the substantially vertically oriented flexible screen frame by application of heat and pressure.

9. The method as claimed in claim 8, further comprising applying the heat and the pressure to the screen mesh and flexible screen frame by application of heater roller assembly.

10. The method as claimed in claim 9, further comprising moving the heater roller assembly proximate the flexible screen frame and screen mesh material by operation of a substantially vertically oriented X-Y movable gantry.

11. The method as claimed in claim 8, further comprising supporting the flexible screen frame at least partially on optionally retractable pins.

12. The method as claimed in claim 11, further comprising selectively advancing and retracting at least some of the pins through horizontally oriented slots in a back frame.

13. The method as claimed in claim 11, further comprising straightening sides of the flexible screen frame by application and movement of at least some of the optionally retractable pins.

14. The method as claimed in claim 8, further comprising tensioning the screen mesh in at least one axis by the operation of gravity.

15. The method as claimed in claim 8, further comprising moving the heater roller assembly around a perimeter of the flexible screen frame while rotating the roller about a z-axis at corners of the flexible screen frame.

16. The method as claimed in claim 15, further comprising rotating the roller about a z-axis by a rotation selected from the group consisting of at least 90° and at least 270°.

17. The method as claimed in claim 8, further comprising removing a laminated window screen from the vertical screen frame laminator to a remote location for trimming excess mesh material.

18. The method as claimed in claim 8, further comprising fusing a portion of the mesh to at least a portion of the flexible screen frame prior to placing the screen frame on the vertical supporting frame.

19. The method as claimed in claim 8, further comprising positioning a frame support rail and an upper frame support rail so that neither is aligned with one of horizontal slots on the substantially vertical supporting frame.
